(19) United States
(12) Patent Application Publication
(10) Pub. No.: US 2026/0276150 A1
(43) Pub. Date: Sep. 17, 2026

(54) Method for Removing Hydrogen, for Completely Emptying a Liquid-Hydrogen Tank, and Use of Same

(71) Applicant: Daimler Truck AG, Leinfelden-Echterdingen (DE)

(72) Inventors: Steffen MAUS, Reutlingen (DE); Jens FRANZEN, Stuttgart (DE); Pia JACOBI, Stuttgart (DE); Roland DOLD, Herrenberg (DE); Ottmar GEHRING, Sindelfingen (DE)

(21) Appl. No.: 18/872,000

(22) PCT Filed: May 9, 2023
(86) PCT No.: PCT/EP2023/062313

§ 371 Date: Dec. 5, 2024

(30) Foreign Application Priority Data
Jun. 7, 2022 (DE) 10 2022 114 284.1

(51) Int. Cl. F17C 9/02

(52) U.S. Cl. CPC F17C 9/02; F17C 2221/012; F17C 2223/0153; F17C 2225/0123; F17C 2227/0304; F17C 2227/0323; F17C 2227/044; F17C 2250/0434; F17C 2250/0439; F17C 2265/066

(57) ABSTRACT

A method for removing hydrogen from a liquid-hydrogen tank having an integrated heating device for evaporating liquid hydrogen and having an emptying line for removing evaporated hydrogen. The method includes supplying heating power for removal of the evaporated hydrogen in order to maintain a tank pressure, detecting a temporal course of the heating power and/or of the tank pressure, and monitoring the temporal course for a sudden change in the heating power and/or a pressure gradient of the tank pressure.

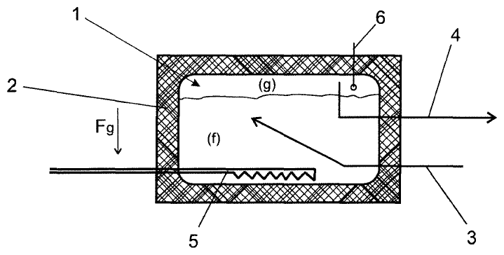

### BACKGROUND AND SUMMARY OF THE INVENTION

The invention relates to a method for removing hydrogen from a liquid-hydrogen tank according to the type defined herein. In addition, the invention relates to a method for completely emptying a liquid-hydrogen tank, from which hydrogen is removed according to the method. Lastly, the invention also relates to the use of one or both of the methods in a liquid-hydrogen tank of a vehicle, in particular a commercial vehicle.

DE 10 2004 061 025 A1 substantially constitutes the relevant prior art. This document discloses a container for condensed gas, which is in the form in particular of a cryo-tank for cryogenic liquid hydrogen. This liquid-hydrogen tank has a heating device for removing hydrogen, which is integrated into the interior of the liquid-hydrogen tank. To remove the hydrogen, this heating device introduces heat into the liquid hydrogen to evaporate it and to maintain the tank pressure so that the evaporated hydrogen can be discharged via an emptying line and can be used to supply a consumer unit in a motor vehicle, for example.

Such liquid-hydrogen tanks or tanks for liquid hydrogen, which is also referred to as LH2, are designed to keep the cryogenic liquid hydrogen in operation for as long as possible and are therefore extremely well thermally insulated from the outside. The hydrogen cannot typically be removed as a liquid, since the removal line is usually attached in the upper region of the tank in the direction of gravity when used as intended. Therefore, a gaseous portion of the hydrogen is removed from a gas cushion that typically forms above the liquid. In the process, the evaporated gas is drawn off and the liquid portion partially evaporates owing to the falling gas pressure to compensate for the low vapor pressure, whereby the pressure rises again. However, in the process, the remaining liquid cools down further, so that the resulting gas pressure increasingly falls during continuous removal. To counteract this and to ensure that there is always a sufficient pressure for the removal of the evaporated hydrogen, heating elements are typically integrated into such liquid-hydrogen tanks, as described in the abovementioned prior art. These heating elements are then used to supply heat from the outside and thus keep the gas pressure at a pressure value suitable for the removal, which is referred to hereinafter as tank pressure.

In practice, temperature and pressure are detected in order to ascertain the fill level of the tank. Furthermore, a fill level sensor can be employed which, due to its operating principle, can only measure up to a lower level. If the liquid level is below this residual filling volume, then it can no longer be detected by the sensor. This is in practice very inaccurate, in particular if the tank is emptied almost completely. Moreover, it would be desirable, if complete emptying of the liquid-hydrogen tank is required, for maintenance purposes for example, to identify when the liquid portion has been completely emptied out or evaporated. None of this is possible using the set-up shown in the prior art.

It is therefore the object of the present invention to specify a method for removing hydrogen from a liquid-hydrogen tank according to the type defined herein, which method avoids the aforementioned disadvantages and guarantees efficient identification of the emptying of the liquid-hydrogen tank. Furthermore, it is the object of the present invention to specify a method based thereon for completely emptying the liquid-hydrogen tank, for example for repair or maintenance work. A further object of the invention consists in specifying a particularly suitable use of the methods.

The method according to the invention for removing hydrogen from a liquid-hydrogen tank provides, similarly to in the prior art, that an integrated heating device is operated in the liquid-hydrogen tank to evaporate liquid hydrogen and to discharge the resultant hydrogen gas through an emptying line. For this, as is known in general and in particular also from the abovementioned prior art, heating power is supplied for removing hydrogen in order to maintain the tank pressure.

According to the invention, it is now provided that the temporal course of the supplied heating power and/or of the tank pressure is detected, wherein the course is monitored for a sudden change in the heating power and/or the pressure gradient.

Such monitoring for a sudden change in the heating power and/or the pressure gradient makes it possible to ascertain when the liquid-hydrogen tank becomes empty, or when the liquid hydrogen stored therein has been completely evaporated, so that after the removal of the remaining gas from the liquid-hydrogen tank, it is correspondingly empty. Unlike when using pressure and temperature sensors, evaluating the temporal course of the heating power and/or the pressure gradient offers a very reliable and efficient way of efficiently predicting the complete evaporation of the liquid hydrogen and thus the imminent complete emptying of the tank. The temporal course of the heating power and/or the pressure gradient is reliable and meaningful, unlike the case when only temperatures and pressures are monitored, in particular since the temperatures inside the liquid-hydrogen tank undergo strong fluctuations as the tank empties and can vary greatly depending on the position of the temperature sensor inside the liquid-hydrogen tank.

According to a very advantageous refinement of the method according to the invention, an electric heating element can be used as heating device, the heating power of which is adjusted to the tank pressure continuously or in a pulse-width-modulated manner, with the electric heating power being detected and evaluated in the manner mentioned in the introduction. This is particularly simple and efficient, since it is possible to detect the heating power of an electric heating element simply and efficiently by measuring the electrical parameters voltage and current.

In addition or alternatively thereto, it can also be provided in one advantageous refinement of the method according to the invention that the heating device comprises a heat exchanger through which a heating medium flows, wherein the heating power is detected on the basis of the volume flow of the heating medium and the difference in temperature upstream and downstream of the heat exchanger. Such a heating can be realized, for example, via a cooling system of an installation that is present anyway. If the hydrogen is converted into electrical power in a fuel cell system for example, this fuel cell system typically has a cooling circuit. The cooling medium of such a cooling circuit can then be used as heating medium for the heat exchanger for heating the heating device of the liquid-hydrogen tank. The waste heat arising from the fuel cell system, which has to be cooled down anyway, is available without the need for additional energy. This type of heating can thus increase the overall efficiency. In order to be able to accordingly detect the heating power introduced, the volume flow and the temperature difference can be detected in the abovementioned manner. In particular, the volume flow can be used as a control parameter for setting the necessary tank pressure and be adjusted to this. This can preferably be realized by a conveyor for the heating medium, the speed of which can be continuously controlled, by a pulse-width-modulated or proportionally controlled valve device or the like.

A very favorable embodiment of the method according to the invention provides that when monitoring the heating power, this is monitored for a sudden drop. This is based on the consideration that, typically, to evaporate the liquid hydrogen in the liquid-hydrogen tank via the heating device in the interior of this liquid-hydrogen tank, it is necessary to supply energy to evaporate the hydrogen. This so-called enthalpy of vaporization is in this case approximately 350 kJ/kg H2. As soon as the liquid hydrogen has completely evaporated and therefore only gaseous hydrogen remains in the liquid-hydrogen tank, this enthalpy of vaporization no longer needs to be applied. The energy to be supplied therefore falls significantly when the hydrogen is being constantly removed and thus the tank pressure is also constant, resulting in a noticeable sudden drop in the heating power to maintain the tank pressure. This sudden fall the heating power is therefore a reliable indicator that the liquid hydrogen in the liquid-hydrogen tank has been completely evaporated.

Monitoring the temporal course of the heating power therefore relies on a constant removal of the hydrogen and thus a constant tank pressure, which is regulated in particular by the heating power. If this is not the case and the heating power is supplied in a switching or in a pulsed manner, then the pressure will also adapt cyclically to this pulsation of the heating power. This means that the pressure rises cyclically when heating takes place or falls when heating does not take place. Here as well, if the liquid hydrogen in the liquid-hydrogen tank has completely evaporated, the enthalpy of vaporization leads to a change in pressure. For this purpose, the pressure gradient can be monitored if the heating power is cyclically switched on and off. If heating is currently taking place, the pressure will rise faster than before, and therefore the pressure gradient jumps upwards. If heating is not currently taking place, because the heating power is switched off at this point in time in accordance with its pulsation, the pressure drops much more quickly than before and therefore the pressure gradient jumps downwards. In this particularly favorable refinement of the method according to the invention, such a jump in the pressure gradient can, in the case of heating power supplied in a pulsed manner, ideally be utilized to ascertain that the liquid hydrogen in the liquid-hydrogen tank has completely evaporated.

According to a very advantageous refinement of the method according to the invention, it can now furthermore be provided that if a sudden change is detected, be it in the heating power and/or the pressure gradient, a warning message is generated. Such a warning message can warn, for example, of an empty tank for liquid hydrogen and thus ensure that the liquid-hydrogen tank can be rapidly refilled, or, for the case of intentional emptying of the liquid-hydrogen tank, for example for maintenance purposes, for dismantling or the like, it can show that the liquid hydrogen has been completely evaporated.

The method according to the invention for completely emptying a liquid-hydrogen tank, from which hydrogen is removed according to the above-described method in one of the described embodiments, can now provide that after the sudden change is detected, for example if the warning message is generated as per the last-described embodiment, the liquid-hydrogen tank is heated further if necessary until a limit temperature is reached and subsequently inert gas is purged. This gas can in particular be nitrogen. The limit temperature is specified as being greater than or equal to the boiling point of the inert gas. For nitrogen, for example, this would be −196° C. This ensures that the nitrogen introduced to purge the liquid-hydrogen tank is not liquefied inside the very well thermally insulated liquid-hydrogen tank, but is present as a gas, in order to purge the gaseous hydrogen remaining in the liquid-hydrogen tank, so that safe maintenance, dismantling or the like of the liquid-hydrogen tank is possible.

The method described in the introduction for removing hydrogen from a liquid-hydrogen tank is particularly suitable for removing hydrogen from a liquid-hydrogen tank of a vehicle that is propelled at least partially by means of the removed hydrogen. The removed hydrogen is supplied to a consumer unit inside the vehicle, for example a hydrogen-operated combustion engine, such as an internal combustion engine, a gas turbine or the like, or it is turned into electricity in a fuel cell system and is used to electrically power the vehicle. The method according to the invention is particularly ideally suited to such applications. It enables the empty state of the liquid-hydrogen tank to be ascertained safely, reliably and in good time largely independently of environmental parameters, which can vary very slightly.

In addition, the method, in particular in combination with the previously described method for completely emptying a liquid-hydrogen tank, enables safe emptying, for example so as to be able to perform maintenance work, repairs or the like on the vehicle, in which case no hydrogen should remain in the liquid-hydrogen tank. This could be because the maintenance directly involves the liquid-hydrogen tank or the tank system or because a relatively long maintenance phase or shutdown time is expected, during which the outward diffusion of hydrogen, for example inside a vehicle depot, is to be reliably prevented.

According to a further very favorable embodiment of this use in a vehicle, it can be provided that in the event of a warning message, a remaining range of the vehicle is estimated and is output together with the warning message. As already mentioned, the sudden change in the heating power and/or the pressure gradient detects the point in time at which all the liquid hydrogen inside the liquid-hydrogen tank has evaporated. The liquid-hydrogen tank is still filled with gaseous hydrogen at this point in time, so that at this point in time, which has been detected by the sudden change, there is a residual amount of gaseous hydrogen that corresponds to the volume of the liquid-hydrogen tank. This residual amount that is dependent on the volume and pressure can be determined using a simple pressure measurement and makes it possible to estimate the remaining range of the vehicle that can still be achieved with the gaseous hydrogen that has already evaporated. The warning to a person driving the vehicle, or to a control centre in the case of a self-driving or partly self-driving vehicle, therefore makes it possible to take appropriate measures, such as switching to another energy source, refuelling with hydrogen or the like.

Further advantageous embodiments of the method according to the invention and its use also arise from the exemplary embodiment, which is described in detail hereinafter with reference to the FIGURE.

### BRIEF DESCRIPTION OF THE DRAWING

The single attached FIGURE shows the schematic illustration of a liquid-hydrogen tank, with which the methods according to the invention can be carried out, and which is suitable in particular for use in a vehicle.

### DETAILED DESCRIPTION OF THE DRAWING

In the illustration in the FIGURE, a liquid-hydrogen tank labelled 1 in its entirety can be seen inside thermal insulation 2. Such liquid-hydrogen tanks 1, which are also referred to as cryogenic tanks or cryo-tanks, are used to store liquid hydrogen at correspondingly low temperatures, so that this hydrogen is liquid at least in the lower region of the liquid-hydrogen tank 1 in the direction of gravity F_{g}. The liquid-hydrogen tank 1 can be filled via a filling line 3. Hydrogen can be removed from the liquid-hydrogen tank 1 via a removal line 4. In the simplified illustration selected here, valve elements, filters, non-return elements and the like have been dispensed with inside these two lines 3, 4. Moreover, typically, a liquid-hydrogen tank 1 is provided with a discharge flue (not shown here) via which gas can be discharged through a pressure relief valve, a rupture element or the like if a safety-critical excess pressure occurs in the liquid-hydrogen tank 1.

Hydrogen is now removed from the liquid-hydrogen tank 1 in regular operation, or also for the case that this has to be completely emptied, in order to perform maintenance on the liquid-hydrogen tank 1 itself or a tank system connected thereto, for example. In the process, a complete removal of the liquid hydrogen as liquid is typically neither provided nor possible, in particular since the filling line 3, as is indicated here, does not typically end in the lower region of the liquid-hydrogen tank 1 or its internal volume in the direction of gravity g when it is used as intended. Rather, the removal line 4 is responsible for the removal, via which gaseous cold hydrogen is removed from the liquid-hydrogen tank 1. This gaseous hydrogen, which collects as a gas cushion (g) above the liquid (f) in the liquid-hydrogen tank 1, is typically always present and can be removed via the removal line 4. As a result, the gas pressure in the liquid-hydrogen tank 1 drops and a part of the liquid hydrogen evaporates to compensate for the falling tank pressure. As a result, the gas pressure rises again. However, the remaining liquid cools down further due to the enthalpy of vaporization required for the evaporation, so that in the case of continuous removal, the resulting tank pressure likewise continues to drop. As soon as the tank pressure drops below atmospheric pressure, removal is no longer possible in principle. In practice, the removal typically takes place for the hydrogen to be consumed, for example in a fuel cell system. Since a certain hydrogen pressure is required inside the system consuming it, removal would only be possible up to this necessary system pressure.

In practice, therefore, it is generally common that the liquid-hydrogen tank 1 comprises a heating device 5 integrated into its internal volume, using which heat can be supplied from the outside so as to evaporate hydrogen. Therefore, the tank pressure can be maintained or adjusted to a desired pressure value. This makes it possible to continuously remove hydrogen from the liquid-hydrogen tank 1.

In order to ascertain whether the liquid-hydrogen tank 1 has been emptied, it is necessary to detect whether there is still liquid hydrogen in the liquid-hydrogen tank 1 or whether only cold hydrogen gas is still in the liquid-hydrogen tank 1. In addition to a pressure sensor 6, which for example is used to regulate the heating power of the heating device 5, there is typically also a temperature sensor (not shown here) in the liquid-hydrogen tank 1. However, this can only be used to a limited extent to ascertain whether a tank is empty since the temperature, in particular in the case of rapid emptying, can vary locally to a great degree. This applies in particular when there are residues of liquid hydrogen in the liquid-hydrogen tank 1, which, for example due to dynamic movements of the liquid-hydrogen tank 1 if the latter is installed in a vehicle, can also get into different regions in the internal volume of the liquid-hydrogen tank 1, for example by sloshing movements or the like.

The typical procedure for removing hydrogen from the liquid-hydrogen tank 1 can now be used, however, since as long as there is still liquid hydrogen in the liquid-hydrogen tank 1, it must be evaporated via a continuous heat supply so that the pressure in the region of the pressure sensor 6 is maintained. The required energy supply corresponds in this case to the enthalpy of vaporization of approx. 350 kJ/kg H2, which must be applied via the heating device 5. As soon as the liquid hydrogen in the liquid-hydrogen tank 1 has completely evaporated and only cold gaseous hydrogen remains in the volume of the liquid-hydrogen tank 1, this enthalpy of vaporization no longer needs to be applied. The energy to be supplied and thus the heating power required to maintain the tank pressure therefore drops abruptly.

It is therefore provided to combine a constant removal of hydrogen via the removal line 4 with measuring the course of the necessary heating power at the heating element 5, so that, using the temporal course of the supplied heating power, it can be ascertained when the liquid hydrogen has completely evaporated and the liquid-hydrogen tank is therefore about to be empty. The constant removal can accordingly be detected in regular operation and if necessary recalculated. For removal for emptying the liquid-hydrogen tank 1 for maintenance reasons, removal via an orifice with a fixed cross section is recommended, so that a constant removal mass flow is ensured.

The power can then be measured via a tank control unit, for example by indirectly determining the power using a coolant in a cooling circuit in the vehicle when heating the heating element 5. In this case, the supplied heating power is calculated using the volume flow of this coolant and the difference between the supply and return temperature, i.e., the temperature of the heating medium upstream and downstream of the heating device 5, designed in this case as a heat exchanger. Alternatively, when using a heating device 5, which is designed as an electric heating element, the heating power can be detected directly via the electric parameters.

Irrespective of how the heating power supplied to the heating device 5 to maintain the tank pressure is detected, it is now the case that, when the tank pressure is continuous or removal is continuous or, in the case of a dynamic removal, when values are recalculated for such a continuous removal, at the moment at which the liquid hydrogen in the liquid-hydrogen tank 1 has completely evaporated, the enthalpy of vaporization no longer needs to be applied. The necessary amount of heat therefore drops abruptly, so that the heating power required for the continuous removal and/or for maintaining the tank pressure also falls abruptly. This sudden fall in the heating power is then an indication that the liquid hydrogen has completely evaporated. The liquid-hydrogen tank 1 is therefore empty, apart from the residual cold gaseous hydrogen remaining in the volume of the liquid-hydrogen tank 1.

If the heating power is applied in a pulsating manner, i.e., it is switched on and off again and again, the pressure inside the volume also rises cyclically whenever heating is taking place, or falls whenever heating is not taking place. In this case, a jump in the pressure gradient can be used to detect when the state in which the liquid hydrogen has completely evaporated in the volume has been reached. If heating is currently taking place, the pressure rises more quickly than before, and the pressure gradient therefore jumps upwards. If heating is not currently taking place, then the pressure accordingly falls more quickly than before, and the pressure gradient therefore jumps downwards in this case.

The described state, in which the liquid hydrogen has completely evaporated and therefore shortly before the liquid-hydrogen tank 1 becomes empty, can be detected via a sudden change in the heating power or in the pressure gradient if the heating power is introduced in a pulsed manner. In this case, a warning message can be generated, for example if the liquid-hydrogen tank 1 is used in a vehicle to provide hydrogen for a fuel cell system. The warning message can then be output to the driver or, in the case of a self-driving vehicle, to a control centre. This is particularly efficient, since in this state of the liquid-hydrogen tank 1, a fill level display which is based on pressure and temperature is relatively worthless for the reasons already described above. It this case, the cold hydrogen gas in the liquid-hydrogen tank 1 can still be used to cover a short stretch of road, meaning that emergency operation is therefore possible. The warning message that is output can in particular comprise the warning about the empty liquid-hydrogen tank 1 and an estimated remaining range based on the amount of gas remaining in the liquid-hydrogen tank 1. When estimating the remaining range, it is also conceivable and logical to consider the state of charge of a typically present hybrid battery, the current vehicle weight, a route topography or the like.

If the liquid-hydrogen tank 1 is to be completely emptied, the sudden change in the heating power and/or the pressure gradient now indicates that the liquid hydrogen in the liquid-hydrogen tank 1 has completely evaporated. In order to now empty the liquid-hydrogen tank 1 further, it can be filled with a non-flammable inert gas, such as nitrogen, in order to purge the remaining hydrogen and a ensure a safe state. For this, it is usually necessary to heat the liquid-hydrogen tank 1 further once the liquid hydrogen has completely evaporated until the gaseous hydrogen remaining in the liquid-hydrogen tank 1 can be replaced by the non-flammable gas. Typically, the hydrogen gas inside the tank is at around −230° C. after the complete evaporation of the liquid phase. Introduced nitrogen would liquefy or even solidify at these temperatures, which is why the gas and thus the liquid-hydrogen tank 1 has to be heated to a temperature of at least −196° C.—the boiling point of nitrogen—before the nitrogen can be added. When using other inert or non-flammable gases or gas mixtures, this temperature can change accordingly, or when using helium or, to a limited extent, also neon, heating can be dispensed with entirely, since the boiling point of these gases is below −230° C. However the disadvantage of noble gases is that they entail very high costs.

Finally, the liquid-hydrogen tank 1 is then purged with the inert gas until the internal temperature of the liquid-hydrogen tank 1 has adapted to the ambient temperature and the residual concentration of hydrogen inside the liquid-hydrogen tank 1 is so low that on contact with air, no explosive or combustible mixture will form.

1.-10. (canceled)

11. A method for removing hydrogen from a liquid-hydrogen tank (1) having an integrated heating device (5) for evaporating liquid hydrogen and having an emptying line (4) for removing evaporated hydrogen, comprising the steps of:
supplying heating power for removal of the evaporated hydrogen in order to maintain a tank pressure;
detecting a temporal course of the heating power and/or of the tank pressure; and
monitoring the temporal course for a sudden change in the heating power and/or a pressure gradient of the tank pressure.

12. The method according to claim 11, wherein the integrated heating device (5) is an electric heating element and wherein a heating power of the electric heating element is supplied continuously or in a pulsed manner.

13. The method according to claim 11, wherein a heating medium flows through a heat exchanger in the integrated heating device (5) and wherein the heating power is detected on a basis of a volume flow of the heating medium and a difference in temperature upstream and downstream of the heat exchanger.

14. The method according to claim 11, wherein in a case of a continuously adjusted heating power, the continuously adjusted heating power is monitored for a sudden drop in an event of a constant removal of the hydrogen.

15. The method according to claim 11, wherein the pressure gradient is monitored when the heating power is supplied in a pulsed manner and wherein the pressure gradient is monitored for a sudden rise or a sudden fall depending on whether heating is currently taking place or not.

16. The method according to claim 11, further comprising the steps of generating and outputting a warning message when the sudden change is detected.

17. A method for completely emptying a liquid-hydrogen tank (1), from which hydrogen is removed according to the method according to claim 11, comprising the steps of:
after the sudden change is detected, heating the liquid-hydrogen tank (1) until a limit temperature is reached and subsequently purging the liquid-hydrogen tank (1) with an inert gas.

18. The method according to claim 17, wherein the limit temperature is greater than or equal to a boiling point of the inert gas.

19. The method according to claim 11, further comprising the step of propelling a vehicle at least partially by removed hydrogen, wherein the removed hydrogen is supplied to a combustion process or an electricity generation process in a fuel cell system of the vehicle.

20. The method according to claim 19, wherein in an event of a warning message, a remaining range of the vehicle is estimated and is output together with the warning message.
